(19) United States
(12) Patent Application Publication
(10) Pub. No.: US 2017/0306511 A1
(43) Pub. Date: Oct. 26, 2017

(54) Crystalline transition metal oxide particles and continuous method of producing the same

(71) Applicant: Inkron Ltd, Hong Kong (HK)

(72) Inventors: Juha RANTALA, Espoo (FI); Thomas GADDA, Espoo (FI)

(21) Appl. No.: 15/507,264

(22) PCT Filed: Aug. 27, 2015
(86) PCT No.: PCT/FI2015/050553

§ 371 Date: Feb. 28, 2017

(30) Foreign Application Priority Data
Aug. 28, 2014 (FI) 20145748

(51) Int. Cl. C25B 1/21; C01G 45/02; H01M 4/50; C01B 25/18; C01B 17/50; C01B 7/00

(52) U.S. Cl. CPC C25B 1/21; C01G 45/02; H01M 4/50; C01B 17/503; C01B 7/00; C01B 25/18

(57) ABSTRACT

Metal oxide particles, preferably crystalline transition metal oxide particles, made via a continuous process comprising application of a voltage across an electrolyte solution. The electrolyte solution includes a transition metal salt dissolved in water, and preferably also includes a compound for increasing the electrical conductivity of the electrolyte. The particles made by the processes disclosed herein, can have sizes in the micrometer or nanometer ranges. The oxide particles can have a variety of uses, including for charge storage devices. As an example, crystalline manganese oxide nanoparticles, and methods for making the same, are disclosed for a variety of uses including lithium ion batteries.

### TECHNICAL FIELD

The present invention relates to metal oxide particles, to uses thereof and to the production of the particles. In particular, the present invention concerns transition metal oxide particles which are prepared one or more steps in a process of applying a voltage across an electrolyte solution.

### BACKGROUND

Metal oxides and in particular manganese oxides (MnO₂) have found several uses in several practical applications such as primary batteries, rechargeable batteries, electromagnetic radiation absorption, catalyst, antibacterial effect and sterilization applications. Until recently only micrometer scales particles have been used but some studies indicate that applying sub micrometer scale particles, i.e., oxide nanoparticles several advantages over larger particles can be obtained. Known synthesis and manufacturing methods of making oxide nanoparticles are described to be chemical precipitation, hydrothermal precipitation, flame pyrolysis and mechanical grinding.

Various types of manganese dioxides (MnO₂) have been employed as catalysts and especially as electroactive materials in electrochemical capacitors and batteries. This is due to their great abundance, low cost, favorable charge density, high electrochemical and chemical stability and low toxicity. The modern electronic devices, such as digital cameras and cordless tools, require batteries to be better suited for the high-power application. Despite of significant advances in the development and commercialization of new battery systems, the alkaline Zn/MnO₂ battery still occupies a major battery market share due to its favorable cost and low toxicity. However, the current commercial alkaline Zn/MnO₂ battery that uses electrolytic manganese dioxide as cathode cannot meet the requirements of the new generation of electronic devices in high rate performance. For example, only 30%-40% of the active cathode material in an alkaline Zn/MnO₂ battery is utilized in a high-power electronic device.

Therefore, it is necessary to improve the high rate performance of the alkaline Zn/MnO₂ battery for the development of new electronic devices.

There are many factors that affect the performance of the alkaline Zn/MnO₂ battery. The nature of the cathode plays an important role in the limitation of the performance of the battery compared to other factors. The active material of a cathode used in current alkaline Zn/MnO₂ battery is electrolytic manganese dioxide (EMD). The commercial EMD has a relatively small specific surface area (about 40 m²/g). The low specific surface area limits the contact area between the electrolyte and MnO₂, leading to a low utilization and rate capacity, especially at a high rate condition. Therefore, increasing the specific surface area of MnO₂ is an effective way to improve the performance of the Zn/MnO₂ battery. Nanoscale materials have special physical and chemical properties and nanostructure provides the materials with a large surface area. Nano manganese dioxide can be used for various applications, such as molecule/ion sieves, catalysts, magnetic materials, battery materials, supercapacitors, and cathodic electrocatalysts for fuel cells.

A second factor that affects the performance of the alkaline Zn/MnO₂ battery is the crystalline phase of the EMD. Manganese oxide has several crystalline phases and ability to control the crystalline phases while simultaneously achieving nanoscale materials is challenging. Up to now, many methods have been proposed for the preparation of nano manganese oxide, including simple reduction, coprecipitation, thermal decomposition, and sol-gel processes. These methods are complicated, usually under wild conditions, and the specific surface area of the products is not much larger than that of the commercial EMD. However, until now EMD cannot produce free and aggregate free nano particulate powders.

Chemical reduction of metal oxides with a salt having the same cation, albeit with a lower oxidation state than that of the metal oxide, or another suitable reducing agent, can be used to prepare metal oxides exhibiting a lower oxidation state with respect to the metal. However, these chemical reduction reactions frequently produce materials that have different crystal structure and degree of crystallinity when compared to materials that are prepared by electrochemical reactions. For instance, manganese oxide obtained by reaction of KMnO4 and a managanese (II) salt typically yields mostly and amorphous managanese oxide with limited degree of α-crystal structure.

The cathode materials for Li-ion batteries are usually oxides of transition metals due to their high electrochemical potentials during highly reversible lithium insertion/deinsertion. There is literature available on the preparative, structural, and electrochemical studies of oxides of Co, Ni, Mn, and V with regard to lithium battery cathodes. Recently, nanoparticles have been suggested as electrode materials for Li batteries. Possible advantages of nanoparticles as active mass in electrodes for Li batteries may relate to high rate capability. Since the rate-determining step in Li insertion electrodes is supposed to be solid-state diffusion (Li ions in the bulk of the active mass), the smaller the particles, the smaller is the diffusion length, and the electrode's kinetics are expected to be faster. The utility of MnO₂ compounds in lithium rechargeable batteries was discussed extensively in the past and has also been demonstrated in commercial rechargeable lithium batteries. Reversible Li insertion around 4.1 V (vs Li/Li+), abundance of manganese in the earth's crust, and relatively low toxicity are the advantages of the LiMn₂O₄ spinel as compared to lithiated cobalt and nickel oxides. Synthetic routes leading to the formation of LiMn₂O₄ published so far include a calcination step at high elevated temperature for long time period as a major and critical step. These methods produce microparticles.

Metal oxide particles find also applications in radiofrequency such as microwave absorption. Microwaves are electromagnetic waves with a frequency range in the electromagnetic spectrum of 300 MHz to 300 GHz. However, most applications of microwave technology make use of frequencies in the range of 1-40 GHz. With the rapid advancements in wireless communications the density of radiofrequency waves and microwaves in our surroundings is becoming a serious problem. Electronic devices such as personal hand phones and personal computers emit electromagnetic waves, causing serious electromagnetic interference phenomena and resulting in wave pollution problems. In order to prevent such phenomena, electromagnetic (EM) waves absorbing materials are generally used.

The use of electromagnetic absorbers can ease this problem and, therefore, absorbers of electromagnetic waves are becoming increasingly important for applications outside special fields like silent rooms, radar systems and military applications. Promising electromagnetic wave absorbers have been widely investigated to eliminate the above problems; in particular, an absorber with a plate structure has become the focus of study because of its practical and simple preparation method. Manganese dioxide (MnO₂) is also one of the raw materials of manganese ferrite, which has wide application in military and civil engineering for its excellent wave absorbing performance in lower frequency bands. However, to the best of our knowledge, there are no reported results on the electromagnetic characteristic and wave absorbing mechanism of MnO₂ nanoparticulate and in particular electrolytically produced and agglomerate free MnO₂ nanoparticle powders.

Beyond above-mentioned electrical applications metal oxide nanoparticles such as MnO₂ can also find applications in antibacterial applications due to their high oxidation capability to disrupt the integrity of the bacterial cell envelope through oxidation similar to other antibacterial agents such as ozone and chlorine.

Background art is represented by US 2013199673, CN 102243373, US2012093680, WO0027754, F120135869 and WO 2014096556.

### SUMMARY

The present invention is related to oxide particles, preferably transition metal oxide particles, made by the application of a voltage across an electrolyte solution in one step of the production process to form a metal oxide with a high level oxidation state.

The electrolyte solution includes a transition metal salt in water, and preferably also includes a compound for increasing the electrical conductivity of the electrolyte.

In further process steps, the obtained metal oxide exhibiting high level oxidation state can be in situ or in a separate vessel be subjected to a reductive reaction with a metal salt exhibiting low oxidation state, or another suitable reducing agent, resulting in the precipitation of a metal oxide particle in solution that can be recovered by various means. In this way desired metal oxide particles can be obtained. Under these conditions, the process can also be operated in a continuous manner by continuous formation of the metal oxide exhibiting high level oxidation state and a separate feed of the metal salt or another suitable reducing agent.

In one embodiment of the invention, a method is provided for making metal oxide particles that includes mixing with water, together or separately, a transition metal salt, and a soluble conductivity enhancing compound, so as to form an electrolyte solution. The electrolyte solution is provided between electrodes, and potentiostatic voltage pulse electrolysis is performed so as to cause the formation of metal oxides. The metal oxides become separated from the first or second electrode back into the electrolytic solution, and are then allowed to react with metal salts to form metal oxide particles which can be separated from the electrolytic solution.

Continuous or semicontinuous operation is provided for, comprising reacting the formed metal oxide anion with a suitable, continuous feed of metal salt to obtain metal oxide particles dispersed in solution.

The particles made by the processes disclosed herein, can have sizes in the micrometer or nanometer ranges.

The oxide particles can have a variety of uses, including for charge storage devices. As an example, as indicated above, manganese oxide particles, and methods for making the same, are disclosed for a variety of uses including lithium ion batteries.

### BRIEF DESCRIPTION OF DRAWINGS

FIG. 1 shows an SEM of comparative example 1;

FIG. 2 shows an XRD of chemically produced material (comparative example 1) and electrochemically produced material (example 1);

FIG. 3 shows an SEM of example 1;

FIG. 4 shows an SEM of example 2; and

FIG. 5 shows an SEM of example 3.

### DESCRIPTION OF EMBODIMENTS

Disclosed herein are methods and apparatus for making particles, such as microparticles, nanoparticles, etc.

The processes in their various variations include first forming an aqueous electrolyte, disposing the electrolyte between electrodes, followed by performing electrolysis by applying a potential across the electrodes so as to form the desired particles or a soluble metal oxide. In preferred examples, the electrolyte is an aqueous solution formed by mixing water with a metal salt and a conductivity enhancing compound, followed by applying a voltage across the electrodes and through the electrolyte, which is preferably as a series of voltage pulses. The voltage pulses can be a series of on and off voltages, a series of high and low voltages, a series of forward and reverse voltage pulses, or a combination thereof.

During the voltage pulses, a metal oxide forms which is either solid or a soluble ion. The soluble ion can be further treated with a metal salt or another reducing agent to yield the desired metal oxide particle. This permits the process to operate in a semi-continuous or continuous manner. Such operation is achieved when the electrolyte is fed sequentially or continuous with new reactants to replenish the electrolyte. Alternatively the soluble metal oxide ion is recovered and allowed to react with the reducing compound in a separate process flow or vessel.

Thus, an embodiment comprises a process for making metal oxide particles, in particular crystalline metal oxide particles, which comprises:
mixing with water, together or separately,
   a) a transition metal salt, and
   b) a soluble conductivity enhancing compound
   so as to form an electrolyte solution, the electrolyte solution being provided between electrodes;
applying potentiostatic pulse electrolysis to the solution so as to cause the formation of metal oxide anions at the first or second electrode, wherein soluble metal oxide anions formed separate from the first or second electrode back into the electrolytic solution;
reacting the formed metal oxide anion with a suitable metal salt to obtain metal oxide particles dispersed in solution; and optionally
separating the metal oxide particles from the electrolytic solution.

In one example for making oxide particles, an electrolyte solution is formed from a transition metal salt. Preferably a soluble conductivity enhancing compound is also provided to increase the conductivity of the electrolytic solution. Both the transition metal salt and the soluble conductivity enhancing compound can be added to water, or the transition metal salt can be added to a first source of water, and separately the soluble conductivity enhancing compound can be added to another source of water, and then both solutions combined together to form the electrolyte solution.

The transition metal salt can be any desired transition metal compound that is soluble for the process. The transition metal can be a late transition metal, or an early transition metal. The transition metal is preferably a transition metal from columns 4 to 12 of the periodic table. The transition metal can be any suitable transition metal, though preferably selected from rows 4 to 6 of the periodic table. In one example, the transition metal is selected from row 4 of the periodic table, such as Ti, V, Cr, Mn, Fe, Co, Ni, Cu or Zn. The transition metal could also be selected from row 5 of the periodic table, such as, but not limited to Zr, Nb, Mo, Tc, Ru or Rh. The transition metal salt can be for example a compound that is a nitrate, sulphate, carbonate, phosphate or halogen salt.

The soluble conductivity enhancing compound is a compound that is soluble in the electrolytic process for making the oxide particles. As an example, the conductivity enhancing compound is an acid, such as sulphuric acid, nitric acid, a chlorine containing acid, phosphoric acid or carbonic acid. The conductivity enhancing compound can be a halogen containing salt or acid.

In a preferred example, the conductivity enhancing compound is a polar covalent compound, such as HCl, HBr, HI or H₂SO_{4.} In one example, the transition metal salt and the conductivity enhancing salt are both nitrates or both sulphates. In another example, the transition metal salt comprises a nitrate, sulphate, carbonate, phosphate or halogen group, and the conductivity enhancing salt comprises a nitrate, sulphate, carbonate, phosphate or halogen group that is different from the nitrate, sulphate, carbonate, phosphate or halogen group of the transition metal salt. Preferably the transition metal salt comprises a nitrate, sulphate, carbonate, phosphate or halogen group, and the conductivity enhancing salt comprises a nitrate, sulphate, carbonate, phosphate or halogen group that is the same as the nitrate, sulphate, carbonate, phosphate or halogen group of the transition metal salt.

If desired, additional compounds or additives can be added to the electrolyte solution. Such compounds may be organic solvents, functional organic compounds, surfactants or polymers that impart in a beneficial way to the electrolysis process. More detailed examples of these classes of compounds can be alcohols, ketones, esters, organic acids, organic sulphur containing compounds, various anionic, cationic or non-polar surfactants, as well as functional polymers. The organic solvent can be acetic acid, glycolic acid, oxalic acid, decanoic acid or octanoic acid, among others. The functional polymers may be, but not limited to, copolymers of ethylene and propylene oxide, polyvinyl alcohols and polyvinylpyrrolidone.

The metal oxide particle form in several ways.

One embodiment comprises forming the metal oxides through anodic or cationic oxidation so the metal oxide forms on the surface of the anode or the cathode.

A second embodiment comprises forming the metal oxides through a chemical reaction that takes place in solution upon formation of a soluble metal oxide anion. The soluble oxide anion may then react with components in the electrolyte forming a new chemical entity that precipitates to form a solid particle.

A third embodiment comprises forming purposedly a soluble metal oxide anion, which is then in controlled fashion treated with a desired reactant, optionally in a separate vessel than the electrolytic cell, to obtain a particle which precipitates as a result of a chemical reaction between the metal oxide anion and the desired reactant. The two latter methods are preferred since these permit the particles to be manufactured in a continuous process by sequential addition of one or more reagents.

Based on the above, an embodiment providing for continuous production of metal oxide particles, in particular crystalline metal oxide particles, comprises the steps of:
mixing with water, together or separately,
   a) a transition metal salt, and
   b) a soluble conductivity enhancing compound
   so as to form an electrolyte solution, the electrolyte solution being provided between electrodes;
applying potentiostatic pulse electrolysis to an electrolyte solution so as to cause the formation of metal oxide anions at the first or second electrode,
transferring the metal oxide anion in a separate reaction vessel;
reacting the formed metal oxide anion with a continuous feed of metal salt to obtain metal oxide particles dispersed in solution; and optionally
separating the metal oxide particles from the electrolytic solution.

An embodiment providing for semicontinuous production of metal oxide particles, in particular crystalline metal oxide particles, comprises the steps of:
mixing with water, together or separately,
a) a transition metal salt, and
b) a soluble conductivity enhancing compound
so as to form an electrolyte solution, the electrolyte solution being provided between electrodes;
applying potentiostatic pulse electrolysis to the solution so as to cause the formation of metal oxide anions at the first or second electrode, wherein soluble metal oxide anions are formed become separated from the first or second electrode back into the electrolytic solution;
reacting the formed metal oxide anion with a sequentially added, suitable metal salt to obtain metal oxide particles dispersed in solution; and optionally

separating the metal oxide particles from the electrolytic solution.

Suitable reducing compounds are metal salts with lower oxidation state such as oxidation states I, II or III. Examples of such metal salts are metal halogens, sulphates, carbonates, phosphates, nitrates and the like. Other suitable reducing agents that can be used are organic reducing agents, hydrogen, boranes, phosphines, silanes and the like which preferably do not form covalent or other permanent bonds to the metal oxide upon reaction.

The particle formed can have a diameter of 1 micron or greater on average (e.g. from 1 to 50 microns, or e.g. from 1 to 10 microns), however the methods are preferably used to form oxide nanoparticles having a diameter (or maximum dimension) of less than 1 micron.

In one embodiment, the particles have an average diameter (or maximum dimension) of from 0.01 to 0.90 microns, and preferably from 0.025 to 0.85, e.g. 0.1 to 0.75 microns, and are substantially round.

Another embodiment comprises forming particles having the shapes of elongated rods, thin flakes or petals. Said particles have average largest dimensions in the above mentioned ranges.

Nanoparticles having an average diameter, or maximum dimension, of less than 0.6 microns, e.g. less than 0.5 microns or even less than 0.3 microns, can be made according to the methods herein.

In preferred examples, due to substantial uniformity of the sizes of the particles formed, for a particular average dimension in a range as above, substantially all of the particles formed will have dimensions in such range.

Preferred embodiments comprises providing transition metal oxide particles, in particular crystalline transition metal oxide particles, having a diameter of less than 1 micron, in particular an average diameter of 50 to 750 nm, said particles advantageously exhibiting crystalline ε and γ phases.

The yield of formed metal oxide particles to the solution can be greater than 40%, preferably greater than 50%, including yields of 65% or more (up to 100%, or more commonly 99%).

The pH of the electrolyte during the particle formation is preferably acidic, e.g. a pH of less than 7, such as a pH of from 1 to 6. A pH in the lower part of this range, such as from 1 to 4, or from 1 to 2.5, e.g. from 1 to 2, can be desirable. The temperature of the electrolyte during particle formation can be selected from a variety of temperatures, such as an electrolyte solution heated to a temperature of from 50° C. to 90° C. during particle formation, or from 60° C. to 80° C. during particle formation. However temperatures both lower and higher than these ranges, including less than 50° C., such as at ambient temperature or lower, can be used.

In one example, the conductivity enhancing compound is a polar covalent compound, such as HCl, HBr, HI, HNO₃ or H₂SO₄. It is also possible to use an alkali metal salt for the conductivity enhancing compound, or an alkaline earth metal salt. In such a case the alkali metal could be K or Na, or the alkaline earth metal could be Mg or Ca. Such a salt could also have an ion (anion) selected from NO₃, SO₄, PO₄, BO₃, CLO₄, (COOH)₂ and halogen groups.

The second reagent which is to react with a soluble metal oxide anion that is formed through electrochemical oxidation can be similarly formulated as described above for the electrolyte in terms of its solvent, additives and like which adjust the properties of the solution such a pH, conductivity and affect the particles that eventually form.

The potentiostatic puke electrolysis may include a series of voltage pukes provided from a power source, where the voltages are applied between an anode and cathode. The voltage pulses can include both forward and reverse pulses.

In one example, only one or more forward pulses are provided across the electrodes, without any reverse pukes. However in a preferred example, both one or more forward pulses and one or more reverse voltages are provided.

In one example, a plurality of forward pulses is followed by a plurality of reverse pulses.

In another example, a plurality of forward pulses is followed by a single reverse pulse.

In a third example, a single forward voltage pulse is followed by a plurality of reverse pulses.

In a preferred example, a plurality of both forward and reverse pulses is provided, where each forward pulse is followed by a reverse pulse.

In one example, a forward voltage pulse has a voltage, and optionally a reverse pulse, of 0.5 to 5 V/cm² and a current of from 0.01 to 5 A/cm². The forward voltage pulse is preferably followed by a reverse pulse having a voltage of from 0.01 to 5 A/cm².

In another example, a forward voltage pulse has any desired voltage, such as a voltage pulse of from 0.25 to 25 V/cm², and preferably from 2 to 15 V/cm², and a current of from 0.01 to 5 A/cm², preferably from 0.1 to 5 A/cm². This forward voltage pulse is followed by a reverse pulse having a voltage of from of from 0.25 to 25 V/cm², and preferably from 2 to 15 V/cm², and a current of from 0.1 to 5 A/cm², preferably from 0.1 to 5 A/cm², but of opposite polarity from the forward pulse.

The forward and reverse pulses can be of the same magnitude, or the reverse pulse can be higher or lower than the forward pulse. In a number of examples, the reverse pulse is of lesser magnitude than the forward pulse, such as from 15% to 85% of the magnitude of the forward pulse. Also the length of time of the forward pulses need not be of the same duration throughout the electrolysis, nor do the reverse pulses need to be maintained at the same duration throughout the electrolysis. The forward pulses can be of shorter time duration at an earlier time in the electrolysis process than at a later time (or vice versa). Likewise the reverse pulses can be of shorter time duration at an earlier time in the electrolysis process than at a later time (or vice versa). In addition, the forward pulses and reverse pulses can have the same pulse duration or time width, or the reverse pulses can have a pulse duration different than the pulse duration of the forward pulses (either greater or less than the forward pulses), and this relation or ratio can change during the electrolysis process.

Additionally, there may be a pulse delay between the pulses when no current is being applied in to the electrolytic cell. Such delays may be useful to permit the detachment of growing particles from the anode or cathode, respectively. The pulse delay can be shorter or longer that the forward or reverse pulses. Preferably, the pulse delays should be short to maximize the production yield of the process.

The oxide particles formed can be metalloid oxide particles, though preferably are transition metal oxide particles such as oxide particles of Ce, Zr, Zn, Co, Fe, Mg, Gd, Ti, Sn, Ru, Mn, Cr or Cu. Other oxide particle examples include ZnO, In₂O₃, RuO₂, IrO₂, CrO₂, MnO₂ and ReO₃. Oxides of post transition metals are also examples herein, though oxides of transition metals are preferred examples, with transition metals from columns 3 to 12 and in rows 4 to 6 of the periodic table of elements are preferred (particularly columns 5 to 12 and row 4 of the periodic table).

After formation of the particles, the particles can be separated from the electrolyte solution, such as with a suitable filter or by allowing the particles to separate out over a period of time by gravitational forces, centrifugation, etc. Furthermore separating the formed free flowing particles from the electrolyte may comprise additional hydrocyclone or decanting centrifuge separation step either in batch or continuous mode.

A particular benefit of the use of electrochemical oxidation in the process, or parts of it, is the benefit of obtaining potentially desired crystal structures or particles with higher degree of crystallinity, which cannot be obtained through standard chemical oxidation and reduction reactions. Control of crystallinity may have profound impact on the applicability of the metal oxide particles in their applications. For example, using the method described, it is possible to obtain manganese oxide nanosized material which contains to a significant degree ε and γ phase.

The crystallinity and the phase morphology can further be controlled by adjusting the parametres of the process.

Thus, the present method provides for predominantly crystalline nanoparticles of metal oxides, such as manganese oxide, having ε and γ phases. Such particles may have particle sizes in the range of less than 1 micron, in particular 0.01 to 0.90 microns, and preferably from 0.025 to 0.85, e.g. 0.1 to 0.75 microns. The size is expressed as the average diameter or average maximum size of the particles (). A typical XRD spectrum for the particles is shown in FIG. 2.

Simple chemical reduction of MnSO₄ with KMnO₄ leads to a predominately amorphous material containing some crystalline α-phase. It can be estimated, as discussed below in connection with the examples that the present technology provides crystalline metal oxide particles having a higher degree of crystallinity than particles formed by conventional technology. On an average, the non-crystalline portion of the present particles is less than 50% of the mass, in particular less than 40%, for example less than 20% of the mass of the particles.

After removing the remaining electrolyte solution from the formed particles, the particles can be washed with e.g. deionized water and dried. The particles can then be formulated as a slurry, ink or paste with one or more suitable carriers. Examples of this carrier are water and various organic solvents having 1-10 carbon atoms and one or more functional moiety. Examples of such are alcohol, ether, ketone, halogen, ester, alkane, double bond or aromaticity in the molecule. The carrier solvent molecule may bear one or more of the functional groups.

The final formulation may further consist of more than one carrier solvent i.e. consist of a mixture of chemicals beneficial for a particular application. In addition, the final composition may include various surfactants, polymers or organic acids which permit the particles to perform as expected in their application.

A charge storage device is a further embodiment, wherein a housing comprises a first electrode, a second electrode, and wherein one of the electrodes comprises a material made from the oxide particles disclosed herein. The oxide particles used for making the electrode material in the charge storage device can have a size of from 1 to 10 microns in diameter (or maximum dimension). However, as greater surface area is beneficial for the oxide particles at the electrode in the charge storage device, the particles preferably have an average diameter or maximum dimension of less than 1 micron, such as less than 800 nm, e.g. from 0.2 to 0.7 microns.

In a further example, the particles have an average diameter (or maximum dimension) of from 50 to 850 nm, e.g. from 100 to 700 nm. Preferably the particles are substantially round, rather than elongated rods or flakes.

The charge storage device can be a lithium ion battery that can be rechargeable (or not). It could also be another type of battery such as an alkaline battery. Between the anode and cathode of the charge storage device is an electrolyte comprising a lithium salt and a solvent. The solvent can be an organic solvent such as ethylene carbonate, propylene carbonate, dimethyl carbonate, ethyl methyl carbonate and/or diethyl carbonate.

The anode in the charge storage device can be made of carbon, such as a graphite anode. The cathode in the charge storage device can be a spinel cathode, and can comprise for example a lithium manganese oxide spinel (LiMn₂O₄) made from the manganese oxide particles disclosed herein. Alternatively the oxide particles disclosed herein could be cobalt oxide particles for making a lithium cobalt oxide cathode, or oxide particles for making a lithium nickel manganese cobalt oxide electrode (e.g. a NMC spinel), or oxide particles for making a lithium nickel cobalt aluminium electrode. Preferably the formed electrode has a capacity of at least 175 mAh g⁻¹, preferably at least 200 mAh g⁻¹, and more preferably at least 250 mAh g⁻¹.

Preferably the oxide is substantially free of metallic impurities. The lithium salt in the electrolyte can be LiPF, LiBF, LiCIO or other suitable salt. If the charge storage device is a rechargeable lithium battery, the lithium in the electrolyte can be an intercalated lithium compound. A suitable lithium salt in the battery electrolyte, such as lithium triflate, lithium hexafluorophosphate, lithium perchlorate, lithium tetrafluoroborate, or lithium hexafluoroarsenate monohydrate, or other suitable lithium salt, can be used.

The charge storage device may be equipped with a voltage regulator or temperature sensor as desired. The charge storage device can be a rechargeable lithium ion battery in an electric vehicle, or in a portable electronic device such as a cellular phone or smartphone, laptop, netbook, ebook reader, iPad or Android tablet, etc.

The metal oxide particles can be also coated with additional material layers such as graphite, graphene, another metal oxide (e.g., titanium dioxde) or with metal layer such as silver, nickel, copper or their oxides or gold, platinum and palladium.

The metal oxide may be blended or compounded in various ratios to polymer resins such as siloxanes, acrylates, epoxies, urethanes but not limited to these. Metal oxide containing resin may then be extruded or coated to function as electromagnetic absorber or antibacterial surface. For the antibacterial surface application it is also beneficial that the resin material is porous or partially porous.

The following non-limiting examples illustrate embodiments of the present technology.

### EXAMPLES

### Comparative Example 1

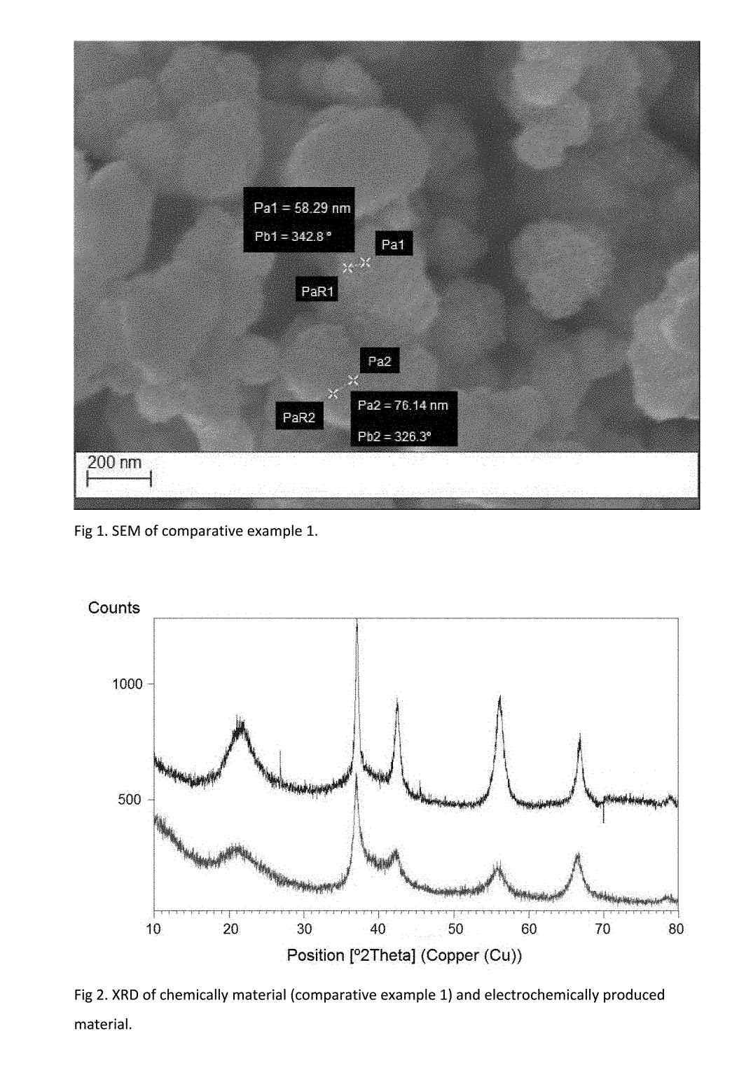

KMnO4 (10.0 g) was dissolved in water (190 mL). Separately, MnSO4 (10.7 g) was dissolved in water (190 mL). The two water solution were brought together by dropwise addition of the MnSO4 solution at room temperature with continuous rapid mixing. A precipitate was immediately obtained. The SEM and XRD was obtained (FIG. 1 and FIG. 2). The primary particle size on average was below 60 nm (FIG. 1).The XRD confirmed crystal structure to be mostly amorphous material with some amounts of ε and γ (FIG. 2). The formed manganese oxide exhibited a potassium content of 2%.

### Example 1

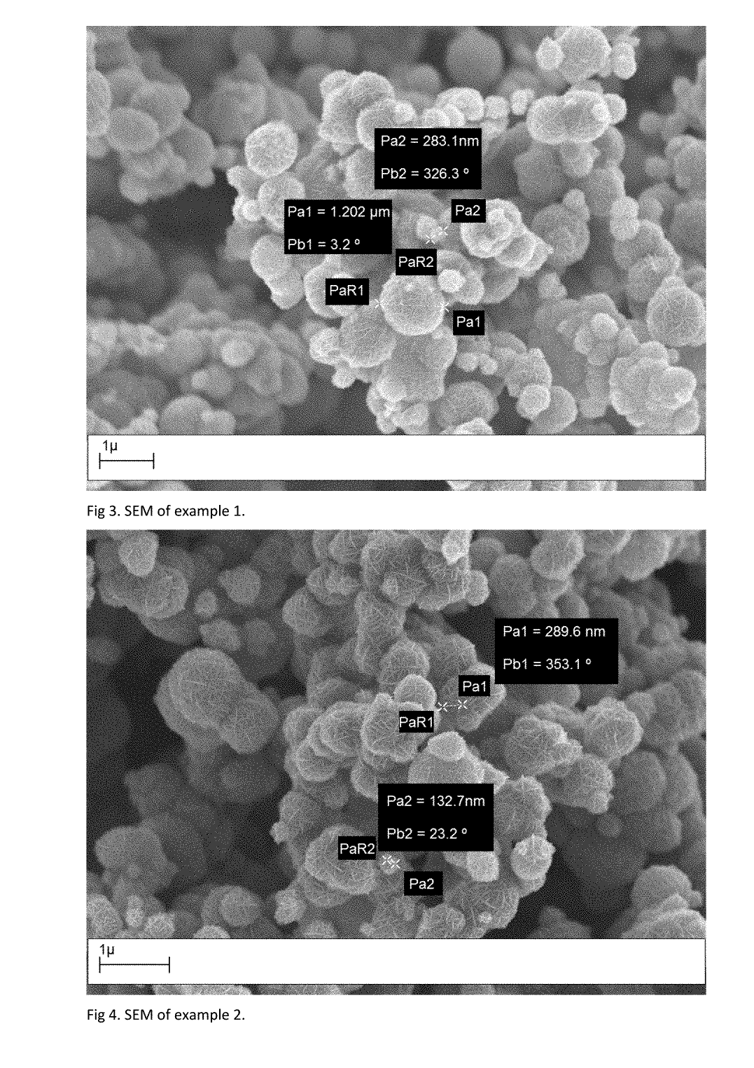

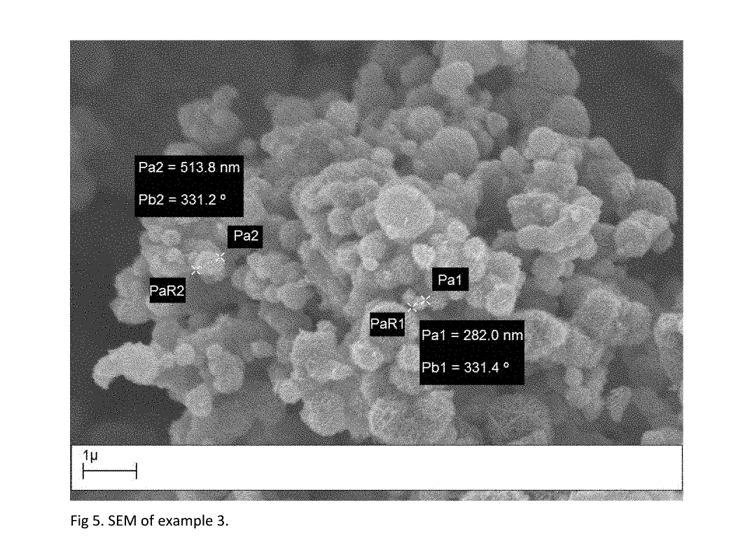

An electrolyte based on MnSO₄.H₂O (0.43 g, 2.5 mmol) and sulphuric acid (0.25 g, 2.6 mmol) in 249.32 g deionized water was prepared in a 300 ml beaker. A stainless steel plates (width 50 mm, thickness 1 mm) and a lead sheet of approximately equivalent size (width 5 mm, thickness 1 mm) were immersed in the electrolyte to a depth of 50 mm. The electrodes were connected to a potentiostat and a pulsed current was applied for synthesis of MnO₂ particles. The forward pulse voltage and current were 15 V and 0.7 A, while the same for the reverse 10V and 0.9 A. The synthesis was carried out for 5 min and the initially clear and colorless solution obtained a dark color due to the formation of solid particles in the solution. The particles settled to the bottom of the vessel they were stored in two days. The clear electrolyte was decanted from the particles and then the particles were re-dispersed into deionized water, allowed to settle, collected and dried. SEM images confirmed that submicron particles were obtained. The primary particle size on average was above 200 nm (FIG. 3).The XRD confirmed crystal structure to contain significantly more of ε and γ (FIG. 2) and less amorphous phase that comparative example 1. The formed manganese oxide free from metal impurities.

### Example 2

The experiment in Example 2 was repeated using an electrolyte based on MnSO₄.H₂O (155 g) and sulphuric acid (90 g) in 29 L of deionized water electrodes of size 7200 cm². The forward pulse voltage and current were 8-15V and 150 A, while the same for the reverse 3-10V and 150 A during operation. The synthesis was carried out for 1 hours and the particles were collected as previously. According to SEM images the primary particle size was 130 nm.

### Example 3

The experiment in Example 2 was repeated using an electrolyte based on MnSO₄.H₂O (155 g) and sulphuric acid (45 g) in 15 L of deionized water. The forward pulse voltage and current were 8-15V and 150 A, while the same for the reverse 3-10V and 150 A during operation. The synthesis was carried out for 1 hours and the particles were collected as previously. According to SEM images the primary particle size was identical to example 3.

### Example 4

The MnO₂ nanoparticles of the Example 1 were coated with silver by mixing the powder with silver nitrate in ethanol and stirring the solution vigorously for 4 hours at room temperature. The silver coated particles were separated and dried. The silver coated MnO₂ powder was then calcinated at elevated temperature. Alternatively MnO₂ particles can be treated first with SnCl₂ or SnCl₂/PdCl₂ treatment sequence prior silver nitrate treatment process.

### Example 5

The test in example 2 was repeated. The product was collected by filtration as previously. The clear, effectively particle free filtrate was collected and the process was repeated using this filtrate. The, amount of MnSO4 equal to the amount in the initial electrolyte was introduced to the filtrate. The filtrate was introduced to the electrolysis cell and a second pulse electrolysis was carried out in a similar way as the first electrolysis. More precipitation was observed once the electrolysis started. The produced amount in the second run was nearly equal (83%) to the amount in the first run. The primary particle size of the first run was 133 nm. The particle size of the second run was the same (143 nm) considering error margins.

Based on these examples it is evident that the present technology provides products with different, improved properties by the use of pulse electrolysis during one or more steps of the synthesis of MnO₂.

In particular, as evidence by example 1, the present technology provides crystalline metal oxide particles having a higher degree of crystallinity than particles formed by conventional technology. On an average, the non-crystalline portion of the present particles is less than 50% of the mass, in particular less than 40%, for example less than 30%, usually less than 20% or even less than 10% of the mass of the particles.

Based on the above, a number of embodiments are further provided:

1. A charge storage device, comprising:
a) a first electrode;
b) a second electrode that comprises electrolytic manganese dioxide (EMD) nanoparticles having an average diameter of from 50 to 850 nm.

2. The device of embodiment 1, wherein the second electrode is a cathode.

3. The device of embodiments 1 or 2, where the charge storage device is a lithium ion battery, in particularly a rechargeable battery.

4. The device of embodiment 3, further comprising an electrolyte comprising a lithium salt and an organic solvent.

5. The device of embodiment 4, wherein the organic solvent is ethylene carbonate, propylene carbonate, dimethyl carbonate, ethyl methyl carbonate and/or diethyl carbonate.

6. The device of embodiments 1 to 5, wherein the lithium salt is LiPF, LiBF or LiClO.

7. The device of embodiments 1 to 6, wherein the charge storage device is an alkaline battery.

8. The device of any of embodiments 1 to 7, wherein the first electrode is a graphite anode.

9. The device of any of embodiments 1 to 8, wherein the nanoparticle diameter is from 100 to 700 nm.

10. The device of any of embodiments 1 to 9, wherein the EMD nanoparticles are substantially free of metallic impurities.

11. The device of any of embodiments 1 to 10, further comprising a voltage regulator and temperature sensor.

12. The device of any of embodiments 1 to 11, wherein substantially all of the EMD nanoparticles have a diameter of from 50 to 850 nm.

13. The device of embodiments 1 to 12, wherein the second electrode is an anode.

14. An EMD product comprising:
a container having therein, electrolytic manganese dioxide (EMD) nanoparticles having an average diameter of from 35 to 850 nm.

15. The product of embodiment 14, wherein the maximum diameter is less than 1 micron.

16. The product of embodiments 14 or 15, wherein the minimum diameter is 50 nm and the maximum diameter is 750 nm.

17. The product of embodiments 14 or 15, wherein the average diameter is from 50 to 750 nm.

18. The product of any of embodiments 14 to 17, wherein the nanoparticles are substantially spherical.

19. The product of any of embodiments 14 to 18 which is substantially free of metallic impurities.

20. The product of any of embodiments 14 to 19, wherein the EMD nanoparticles are provided in the form of a slurry or paste in the container.

21. Transition metal oxide particles obtainable by a process as described herein.

22. A method for making metal oxide particles, comprising:
providing a transition metal salt to water to form an aqueous electrolyte solution;
providing the electrolyte solution between electrodes;
performing potentiostatic pulse electrolysis so as to cause the formation of metal oxide particles at a first electrode of said electrodes,

wherein the potentiostatic pulse electrolysis comprises a series of voltage pulses provided between the electrodes, including forward and reverse voltage pulses;

wherein during the potentiostatic pulse electrolysis, the metal oxide particles form at, and immediately become separated from, the first electrode, so as to form particulate matter in the electrolytic solution; and
separating the metal oxide particles from the electrolytic solution;

said process being carried out continuously or semi-continuously.

23. Transition metal oxide particles obtained by a process as disclosed herein (in particular claim 1 below).

24. Crystalline nanoparticles of metal oxides, in particular transition metal oxides, such as manganese oxide, having ε and γ phases.

25. The nanoparticles of embodiments 23 or 24 having an average particle size in the range of less than 1 micron, in particular 0.01 to 0.90 microns, and preferably from 0.025 to 0.85, e.g. 0.1 to 0.75 microns, the size being expressed as the average diameter or average maximum size of the particles ().

26. The nanoparticles of any of embodiments 23 to 25, the non-crystalline portion of the particles being less than 50% of the mass, in particular less than 40%, for example less than 30%, advantageously less than 20% or even less than 10% of the mass of the particles.

### CITATION LIST

### Patent Literature

US2013199673
CN 102243373
US2012093680
WO0027754
FI20135869
WO 2014096556

1. A process for making metal oxide particles, in particular crystalline metal oxide particles, comprising the steps of:
mixing with water, together or separately,
a) a transition metal salt, and
b) a soluble conductivity enhancing compound
so as to form an electrolyte solution, the electrolyte solution being provided between electrodes;
applying potentiostatic pulse electrolysis to the solution so as to cause the formation of metal oxide anions at the first or second electrode, wherein soluble metal oxide anions formed become separated from the first or second electrode back into the electrolytic solution;
reacting the formed metal oxide anion with a suitable metal salt to obtain metal oxide particles dispersed in solution; and optionally
separating the metal oxide particles from the electrolytic solution.

2. The method of claim 1, wherein the oxide formed is selected from ZnO, In₂O₃, RuO₂, IrO₂, CrO₂, MnO₂ and ReO₃.

3. The method of claim 1 or 2, wherein the metal oxide formed is a metal oxide of one or more of the metals selected from Ce, Zr, Zn, Co, Fe, Mg, Gd, Ti, Sn, Ru, Mn, Cr and Cu.

4. The method of any of claims 1 to 3, wherein the first and second electrodes are an anode and cathode, and wherein a metal oxide anions are formed on the anode and instantaneously decouple from the anode so as to become free to react in the electrolytic solution with metal salts to yield a particle.

5. The method of any of claims 1 to 4, wherein the formation of the metal oxide particles at the anode is an oxidation reaction.

6. The method of any of the preceding claims, wherein the metal oxide particles formed are manganese oxide particles.

7. The method of claim 6, wherein the manganese oxide particles separated from the electrolytic solution have an average diameter of less than 10 microns.

8. The method of claim 7, wherein the particles have an average diameter of less than 1 micron, preferably in the range 0.1 to 0.75 microns.

9. The method of any of claims 1 to 8, wherein the particles are substantially spherical.

10. The method of any of claims 1 to 9, wherein the particles have an average diameter of less than 0.5 microns.

11. The method of any of the preceding claims, wherein the yield of free particles in solution is greater than 40%, preferably greater than 65%.

12. The method of any of claims 1 to 11, wherein the potentiostatic electrolysis comprises a series of voltage pulses applied between the electrodes.

13. The method of any of the preceding claims, further comprising applying ultrasound to the electrolytic solution during electrolysis.

14. The method of any of the preceding claims, wherein the electrolytic solution has a pH of less than 7, preferably the electrolytic solution has a pH of from 1 to 6, in particular the electrolytic solution has a pH of from 1 to 2.5.

15. The method of any of the preceding claims, wherein the conductivity of the electrolytic solution is from 1 to 30 mS/cm.

16. The method of any of the preceding claims, wherein the anode is an array and comprises a plurality of micrometer or sub-micrometer sized electrodes.

17. The method of any of the preceding claims, wherein the potentiostatic electrolysis comprises a series of voltage pulses having a pulse width of less than 1 second, preferably less than 0.5 seconds, in particularly less than 0.1 seconds.

18. The method of any of the preceding claims, wherein the transition metal salt comprises a transition metal selected from Ni, W, Pb, Ti, Zn, V, Fe, Co, Cr, Mo, Mn and Ru.

19. The method of any of the preceding claims, wherein the transition metal is an early transition metal.

20. The method of any of the preceding claims, wherein the transition metal salt is a nitrate, sulphate, carbonate, phosphate or halogen salt.

21. The method of any of the preceding claims, wherein the soluble conductivity enhancing compound is an acid.

22. The method of claim 21, wherein the soluble conductivity enhancing compound is sulphuric acid, nitric acid, a chlorine containing acid, phosphoric acid or carbonic acid.

23. The method of any of claims 1 to 20, wherein the soluble conductivity enhancing compound is a halogen containing salt or acid.

24. The method of any of claim 1 to 20 or 23, wherein the soluble conductivity enhancing compound is a salt.

25. The method of any of claims 1 to 20, wherein the conductivity enhancing compound is a polar covalent compound.

26. The method of claim 25, wherein the polar covalent compound is HCl, HBr, HI, HNO₃, H₃PO₄ or H₂SO₄.

27. The method of any of the preceding claims, wherein the transition metal salt comprises a late transition metal.

28. The method of any of the preceding claims, wherein both the transition metal salt and the soluble conductivity enhancing compound both comprise the same nitrate, sulphate, carbonate, phosphate or halogen group, preferably the transition metal is manganese or cobalt.

29. The method of any of the preceding claims, wherein in addition to the transition metal salt and conductivity enhancing compound, an organic solvent is added to the solution.

30. The method of claim 29, wherein the organic solvent is an aliphatic acid, preferably the organic solvent is selected from acetic acid, glycolic acid, oxalic acid, decanoic acid, and octanoic acid and combinations thereof.

31. The method of any of the preceding claims, wherein the separated oxide particles are added to a primary or rechargeable battery.

32. The method of any of the preceding claims, wherein the nanoparticles formed have an average maximum dimension of less than 800 nm.

33. The method of any of the preceding claims, wherein the nanoparticles have a maximum dimension of from 0.2 to 0.7 microns.

34. The method of any of the preceding claims, wherein the transition metal salt comprises a transition metal selected from row 4, 5, 6 or 7 of the periodic table.

35. The method of any of the preceding claims, wherein prior to filtering, substantially all of the metal oxide formed are particles in solution.

36. The method of claim 35, wherein substantially all the metal oxide formed at the electrode separates as particles into the electrolyte with substantially no metal oxide remaining adhered to the electrode.

37. The method of any of the preceding claims, wherein the electrolyte has a pH of from 1 to 2 and en electrical conductivity of from 5 to 15 mS/cm

38. The method of any of the preceding claims, wherein the electrolyte solution is heated to 50° C. to 90° C. during particle formation, in particular the electrolyte solution is heated to 60° C. to 80° C. during particle formation.

39. The method of any of claims 4 to 38, wherein the anode is a stainless steel, aluminium, copper or lead anode.

40. The method of any of the preceding claims, wherein the step of separating the metal oxide particles from the electrolytic solution comprises allowing the particles to settle out of the electrolytic solution over a period of time, followed by removal of the electrolytic solution, and washing and drying of the remaining particles.

41. The method of any of the preceding claims, wherein the step of separating the metal oxide particles from the electrolytic solution comprises hydrocyclone or decanting centrifuge separation step.

42. The method of any of the preceding claims, wherein substantially all of the particles have a maximum dimension of less than 1 micron.

43. The method of any of the preceding claims, wherein the transition metal salt comprises a transition metal selected from rows or periods 4 to 7 of the periodic table which can undergo anodic oxidation or cathodic reduction at the first or second electrode.

44. The method of any of the preceding claims, wherein the formed oxide is further coated with silver, copper, nickel, titanium or their oxides, graphene, graphite, carbon nano tube, gold, platinum or palladium.

45. The method of any of the preceding claims, comprising continuously or sequentially feeding metal salt to obtain metal oxide particles dispersed in solution.

46. A continuous process for making metal oxide particles, in particular crystalline metal oxide particles, comprising the steps of:
mixing with water, together or separately,
a) a transition metal salt, and
b) a soluble conductivity enhancing compound
so as to form an electrolyte solution, the electrolyte solution being provided between electrodes;
applying potentiostatic pulse electrolysis to an electrolyte solution so as to cause the formation of metal oxide anions at the first or second electrode,
transferring the metal oxide anion in a separate reaction vessel;
reacting the formed metal oxide anion with a continuous feed of metal salt to obtain metal oxide particles dispersed in solution; and optionally
separating, preferably continuously, the metal oxide particles from the electrolytic solution.

47. A semi-continuous process for making metal oxide particles, in particular crystalline metal oxide particles, comprising the steps of:
mixing with water, together or separately,
a) a transition metal salt, and
b) a soluble conductivity enhancing compound
so as to form an electrolyte solution, the electrolyte solution being provided between electrodes;
applying potentiostatic pulse electrolysis to the solution so as to cause the formation of metal oxide anions at the first or second electrode, wherein soluble metal oxide anions are formed become separated from the first or second electrode back into the electrolytic solution;
reacting the formed metal oxide anion with a sequentially added metal salt to obtain metal oxide particles dispersed in solution; and optionally
separating, preferably continuously, the metal oxide particles from the electrolytic solution.
